(19) United States
(12) Patent Application Publication
(10) Pub. No.: US 2009/0054059 A1
(43) Pub. Date: Feb. 26, 2009

(54) ROAMING DETECTION

(76) Inventors: Stuart Daniel FROHLICH, Ramat Bet Shemesh (IL); David Elliot Goldfarb, Bet Shemesh (IL)

Correspondence Address: DANIEL J SWIRSKY, 55 REUVEN ST., BEIT SHEMESH, 99544, IL

(21) Appl. No.: 12/193,785

(22) Filed: Aug. 19, 2008

Related U.S. Application Data
(60) Provisional application No. 60/957,488, filed on Aug. 23, 2007.

(51) Int. Cl. H04Q 7/20

(52) U.S. Cl. 455/432.1

(57) ABSTRACT

A method includes detecting a roaming status of a mobile communication device communicating with a server as a function of the corresponding IP address of the mobile communications device as presented to the server.

### CROSS-REFERENCE TO RELATED APPLICATIONS

This application claims benefit from U.S. Provisional Patent Application No. 60/957,488, filed Aug. 23, 2007, which is hereby incorporated in its entirety by reference.

### FIELD OF THE INVENTION

The present invention relates to mobile applications generally and to detection of roaming in particular.

### BACKGROUND OF THE INVENTION

Mobile communications devices are ubiquitous. People use them in their local area and sometimes take them out of their local area. The latter practice is known as “roaming” and it often incurs significant charges. These charges may be reasonable when just using a voice channel, but roaming charges for users that frequently transfer data (for accessing the Web, reading email, etc.) are often quite steep.

Unfortunately, many users may be unaware of just how expensive the data charges may be when roaming. Neither their device, nor the carriers (i.e. mobile network operators) warn them. Accordingly, they will often only find out when they are billed, which is typically several days to a few weeks later.

Both the device and the carrier may know when a mobile communications device is roaming. Indeed, the user may know it as well, though he may be unaware of its cost. However, none of these entities provide an indication to any of the applications running on the device.

### SUMMARY OF THE PRESENT INVENTION

An object of the present invention is to improve upon the prior art.

There is therefore provided in accordance with a preferred embodiment of the present invention, a method including detecting a roaming status of a mobile communication device communicating with a server as a function of the corresponding IP address of the mobile communications device as presented to the server.

Further, in accordance with a preferred embodiment of the present invention, the IP address is an external IP address.

Still further, in accordance with a preferred embodiment of the present invention, the method also includes registering a home network with the device.

Additionally, in accordance with a preferred embodiment of the present invention, the registering includes receiving an initial IP address from the device, looking up in an IP lookup table a mobile network operator associated with the initial IP address; and associating a home network with the device in accordance with the looked up mobile network operator.

Moreover, in accordance with a preferred embodiment of the present invention, the registering includes receiving a phone number from the device, forwarding the phone number to a phone number lookup service, receiving from the service an indication of a mobile network operator associated with the phone number, and associating a home network with the device in accordance with the indication.

Further, in accordance with a preferred embodiment of the present invention, the method also includes looking up in a IP lookup table a subsequent IP address received from the device, and determining that the device is roaming if the subsequent IP address is not associated in the lookup table with the home network.

Still further, in accordance with a preferred embodiment of the present invention, the method also includes notifying the device that the device is roaming.

Additionally, in accordance with a preferred embodiment of the present invention, the method also includes prompting a user of the device to authorize continuing communication with the device.

Moreover, in accordance with a preferred embodiment of the present invention, the method also includes receiving a response to the prompting and stopping communications with the device if so indicated by the response.

Finally, the present invention includes apparatus for implementing the method as well as other methods and apparatus as described hereinbelow.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a roaming detection system, designed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention is a method, external to a carrier and/or to the mobile communications device, to determine whether a device may be roaming and to provide an indication of such to the user. This may be useful for servers running applications that download significant amounts of data to the device or that upload such data from the device.

Applicants have realized that, when an application on a mobile communications device may connect to a server on the Internet using a data channel, it may identify itself to the server using an IP address. This IP address may be identified as one that may be assigned to the carrier through which the device may currently be communicating. As the current data-bearing carrier may be identified according to the IP address of the device, the server may then be capable of informing the communicating application that the device may be outside of its “home” carrier network.

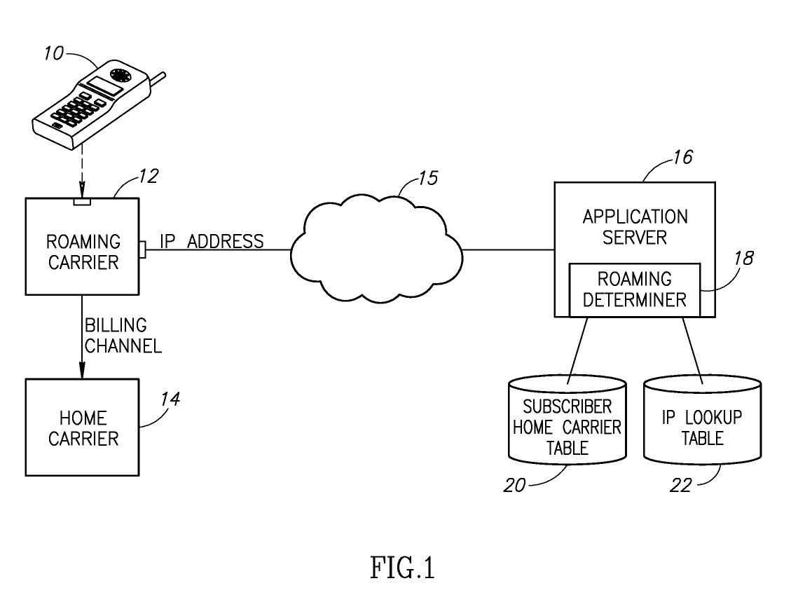

FIG. 1 illustrates a roaming cellular telephone 10 that may be operated by a user (not shown) who may be a subscriber of carrier 14 (the “home” carrier). Telephone 10 may roam and may communicate with roaming carrier 12 which may provide service to a cellular network in an area where telephone 10 may currently be roaming. Roaming carrier 12 may identify telephone 10 as a roaming telephone and may bill home carrier 14 for any use while in the area serviced by roaming carrier 12.

It will be appreciated that cellular telephone 10 is exemplary. The present invention may include any suitable mobile communications device that may be capable of communicating via a data channel as a “roamer” on a mobile communications network.

When telephone 10 may contact an application server 16, which may provide web-based services through the Internet 15, roaming carrier 12 may provide telephone 10 with a temporary IP address, from among a block of IP addresses allocated to carrier 12. Any data that telephone 10 may send to application server 16 may be identified by server 16 as data originating from a telephone serviced by roaming carrier 12.

It will be appreciated that the address that may be presented to external services such as application server 16 may actually differ from the address presented to telephone 10. For example, roaming carrier 12 and/or home carrier 14 may use NAT gateways or similar technologies to multiplex a relatively small number of external IP addresses among a much larger number of internal customers. In such a case, the internal IP address of telephone 10 may differ from the external address presented to application server 16. The method described herein, provides a robust solution in all of these circumstances.

Application server 16 may be any type of server providing any kind of data or service to cellular telephones or to any client requesting this service on the Internet. For example, server 16 may provide content sharing services for cellular telephones, such as those provided by Vringo Inc. of the USA and described in U.S. provisional patent applications 60/771,883 and 60/772,564, and their utility application, U.S. Ser. No. 11/544,938.

In addition to its regular services, application server 16 may also comprise a roaming determiner 18 which may determine if telephone 10 is roaming from the data that it receives from telephone 10. Roaming determiner 18 may comprise a subscriber home carrier table 20 and an IP lookup table 22.

When a user may sign up and for the service provided by application server 16 and/or when the user first uses the service via telephone 10, roaming determiner 18 may use the IP address received with the initial data to look up the user's current carrier in IP lookup table 22. Presumably, this IP address belongs to home carrier 14 (this will be true as long as the sign up and/or the first use is through home carrier 14), and the user telephone 10 may be registered in subscriber home carrier table 20 as a subscriber of home carrier 14.

In accordance with an alternative preferred embodiment of the present invention, the first time the user connects, the server may prompt the user to confirm that he is currently on his home network. If the user responds affirmatively, then roaming determiner 18 may register the user with his current carrier (as indicated by the IP address of data from received from telephone 10) in subscriber home carrier table 20. If not, roaming determiner 18 may continue to prompt the user each time he may reconnect from a new IP address or with an IP address in a new IP range.

In accordance with an alternative preferred embodiment of the present invention, application server 16 may use services, such as the “Number Lookup” service of End2End Mobile, to identify the home carrier associated with telephone 10's telephone number.

Roaming determiner 18 may then check the IP address of subsequent communications from telephone 10 using IP lookup table 22. If IP lookup table 20 indicates that the organization owning the IP address of the current communication may be different than the organization owning the initial IP address for telephone 10 (as listed in initial IP address table 20), then roaming determiner 18 may send a message to telephone 10 (using SMS, response to an IP request, or any other suitable form of communication), warning the user of the possibly high data charges that may be incurred while roaming and prompting the user to authorize further communications with application server 16. If the user may reply ‘Yes’, then the communication may continue. Otherwise, roaming determiner 18 may disconnect the connection.

It will be appreciated that IP lookup table 22 is exemplary. Equivalent functionality may alternatively be provided by an external IP block lookup service. An example of such an external service may be GeoIP, available from MaxMind LLC in the United States.

Roaming determiner 18 may be configured to check for roaming on a periodic or random basis. For example, it may check at the start of every communication from telephone 10, at the end of communications, at random intervals, once a day, or once every few days or communications.

Unless specifically stated otherwise, as apparent from the above discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising
detecting a roaming status of a mobile communication device communicating with a server as a function of the corresponding IP address of said mobile communications device as presented to said server.

2. The method according to claim 1 and wherein said IP address is an external IP address.

3. The method according to claim 1 and also comprising:
registering a home network with said device.

4. The method according to claim 3 and wherein said registering comprises:
receiving an initial IP address from said device; and
looking up in an IP lookup table a mobile network operator associated with said initial IP address; and
associating a home network with said device in accordance with said looked up mobile network operator.

5. The method according to claim 3 and wherein said registering comprises:
receiving a phone number from said device;
forwarding said phone number to a phone number lookup service;
receiving from said service an indication of a mobile network operator associated with said phone number; and
associating a home network with said device in accordance with said indication.

6. The method according to claim 3 and also comprising:
looking up in a IP lookup table a subsequent IP address received from said device; and
determining that said device is roaming if said subsequent IP address is not associated in said lookup table with said home network.

7. The method according to claim 1 and also comprising notifying said device that said device is roaming.

8. The method according to claim 1 and also comprising prompting a user of said device to authorize continuing communication with said device.

9. The method according to claim 6 and also comprising:
receiving a response to said prompting; and
stopping communications with said device if so indicated by said response.
